(19) United States
(12) Patent Application Publication
(10) Pub. No.: US 2011/0047477 A1
(43) Pub. Date: Feb. 24, 2011

(54) METHOD AND SYSTEM FOR TROUBLE TICKET CREATION USING TEMPLATES

(75) Inventors: Chris L. White, Plano, TX (US); Robert Scherer, Newport, NC (US); Robert Miskowitch, Colorado Springs, CO (US)

Correspondence Address: VERIZON;PATENT MANAGEMENT GROUP, 1320 North Court House Road, 9th Floor, ARLINGTON, VA, 22201-2909, US

(73) Assignee: VERIZON PATENT AND LICENSING INC., Basking Ridge, NJ (US)

(21) Appl. No.: 12/544,724

(22) Filed: Aug. 20, 2009

(51) Int. Cl. G06F 3/01

(52) U.S. Cl. 715/747

(57) ABSTRACT

An approach for generating and modifying templates for trouble tickets on demand and assigning the templates to one or more workgroups is provided. Portions of the templates may be associated with a predetermined number of fields.

### BACKGROUND OF THE INVENTION

Modern communication systems involve a delicate interplay of network components that support voice and data services. These systems are vital to business operations, such that downtime imposes a significant cost to the business. The impact of network failures (even very minor ones lasting only minutes) can be measured in thousands or even millions of dollars. Therefore, customers are acutely aware of problems that arise with such systems and have a vested interest in ensuring that such problems are resolved in a timely manner. Networks may utilize trouble ticket systems as an efficient manner in which to keep track of problem events that arise in the system, and to keep track of the steps being taken to resolve such problems. In order to report a problem event, a customer may contact a customer service representative of the service provider who may create a trouble ticket and route the trouble ticket to the appropriate workgroup. Traditionally, trouble tickets have been created using paper checklists, word documents, spread sheets, and non-integrated tools to store checklists, policies, or instructions. This process, thus, is manually intensive, and prone to human error, thereby delaying resolution to the customer and/or end users. Also, this manual process has resulted in inconsistent application of rules and procedures in creation of the trouble tickets.

Based on the foregoing, there is a need for a method and system to improve the trouble ticketing creation process.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of an architecture capable of efficiently creating trouble tickets using templates, according to various embodiments;

FIG. 2 is a diagram of a trouble ticket platform for use with a service provider network for creating and sharing trouble tickets, according to various embodiments;

FIG. 3 is a flowchart of a template creation/modification process for a trouble ticket management system, according to various embodiments;

FIG. 4 is a flowchart of a process associating fields with a field value in a template for a trouble ticket management system, according to various embodiments;

FIGS. 5A-5D are graphical representation of screens corresponding to field, group, template, and assignment tabs, according to various embodiments; and

FIG. 6 is a diagram of a computer system that can be used to implement various embodiments.

### DESCRIPTION OF THE PREFERRED EMBODIMENT

An apparatus, method, and software for providing fault isolation and/or resolution as part of a managed services network are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various exemplary embodiments are described with respect to providing automated fault isolation and/or recovery in a managed services context, it is contemplated that these embodiments have applicability to systems operated solely by customer organizations.

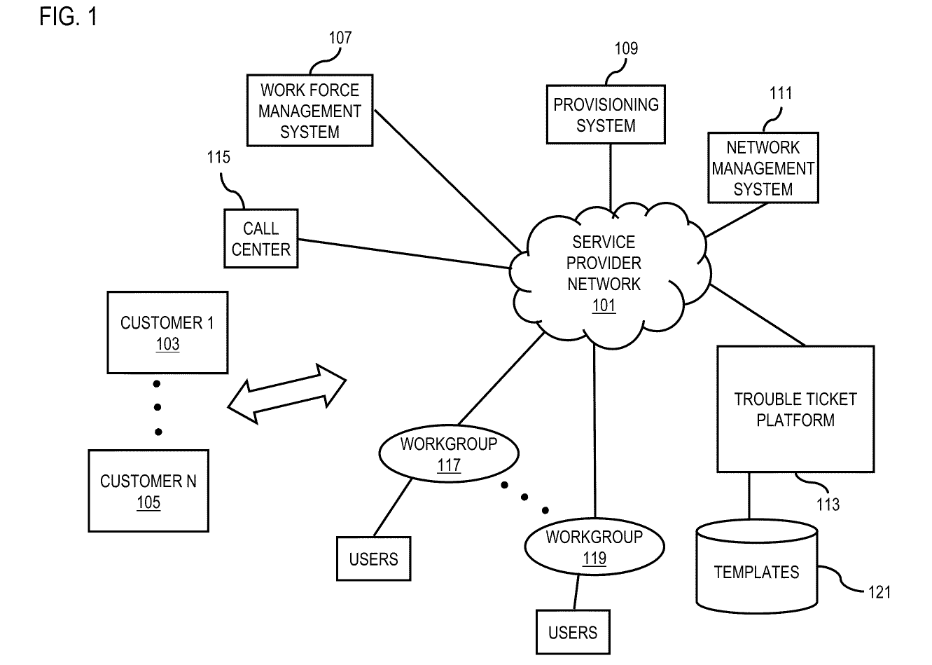

FIG. 1 is a diagram of an architecture for creating trouble tickets for use, for example, with a service provider network 101 that is configured to provide media content or communication services (e.g., voice, data, video, etc.) to various customers (or subscribers), such as customer₁ 103 . . . customer_{N} 105. The customer can be an individual or residence that receives one or more media services from the service provider network 101, either directly or from a content provider via the service provider network 101. The customer could also be an entity, such as a corporation, enterprise, or organization, that receives one or more media services from the service provider network 101, either directly or from a content provider via the service provider network 101. The various communication conduits used to provide one or more media services to the various customers are not expressly depicted in FIG. 1, and can include the use of any form of wired or wireless communication architecture (e.g., land-line, cable, fiber optic, satellite-based, cellular, or other communication architecture).

The service provider network 101 in FIG. 1 includes a workforce management module or unit 107, a provisioning system 109, and a network management system (module or unit) (NMS) 111. The workforce management 107 monitors and controls allocation of workforce to perform various tasks needed to provide customers with the services, such as set-up and maintenance of customer's services. The provisioning system 109 monitors and controls the provisioning of various network resources to particular customers, and the network management 111 manages the various network assets.

In order to process various customer problems and concerns that arise with the customer's services, the service provider network 101 includes a trouble ticket management system 113 and a call center 115.

For example, a service representative would generally follow a question tree to create a trouble ticket. Traditionally, question trees were not tailored for particular repair centers or workgroups. The questions asked by the service representative would not necessarily provide all of the information necessary for a repair center to resolve a given problem. Within an organization, workgroups can be defined according to services, departmental functions, etc. Accordingly, custom forms need to be generated for the different workgroups 117 and 119.

Traditionally, creation of custom forms and templates to add questions directed to a new type of problem (or to remove questions directed to issues no longer encountered) has required funding and significant software development effort. For example, a typical software delivery cycle can take several months. Further, once the investment is made for the particular workgroup, this investment can be readily applied to other workgroups. That is, other workgroups might not have the benefit of a related workgroup's modifications, leading to inconsistency in trouble tickets created.

The trouble ticket platform (or trouble ticket management system) 113 allows for the creation of a trouble ticket for a customer problem, which can be used to track the steps being taken to resolve the problem. To create trouble tickets, trouble ticket management system 113 uses templates created by, for example, users of workgroups 117 and 119. These users may be managers or administrators for the different workgroups 117 and 119, wherein each workgroup is responsible for different tasks in providing customers with services and/or for providing different services to the customers. The users generate trouble ticket templates via trouble ticket platform 113, which can then store these templates within database 121 for sharing among the workgroups 117 and 119.

Trouble ticket platform 113 may be implemented with any suitable interface, such as a conventional call center, an interactive voice response (IVR) unit, a web-based graphical user interface (GUI), and/or any other equivalent interface, for generating and/or receiving trouble tickets. For instance, a customer (e.g., customer 103, 105) may initiate a communication session with an IVR implementation via a plain old telephone service device and provide verbal input concerning a problem the customer is experiencing, such as a loss of network connectivity. In response, trouble ticket platform 113 may generate an electronic record, i.e., a trouble ticket, documenting the problem, as well as append to the record other information, such as customer demographic information. Trouble ticket platform 113 may also include a workflow engine that creates trouble tickets based on network alarms, generated at, for instance, a real-time network monitor (not illustrated) that provides intelligent circuit and element testing data associated with fault detection and isolation.

By way of example, trouble ticket platform 113 can generate trouble tickets including data, such as customer names, telephone numbers, addresses, narratives of the problems, hardware/software affected, related device addresses, fault analysis, network performance, real-time statistics, symptom codes, intrusive test results, severities, statuses, and/or any other suitable information, such as dates, times, reference numbers, related network topology, etc. According to one embodiment, trouble ticket platform 113 structures or compartmentalizes this trouble ticket information into fields, tables, or any other suitable data structure, such as a delimited text file. For example, a trouble ticket data structure may include columns and rows that correspond to particular data fields and data entries, respectively. In any case, a data structure may be propagated with data entries corresponding to the trouble ticket information for the purpose of forming an automated prioritization report, or parts thereof. Alternatively, data structures may be generated automatically. It is noted that the aforementioned data structures are merely exemplary and are not intended to limit the nature or structure of a data source that may be utilized by network management system 111.

In terms of greater consistency and overall quality of trouble tickets, it is beneficial for the service provider network 101 to provide users with flexibility in creating trouble tickets. For example, the ability to create, update, and share templates for trouble tickets allows users to more efficiently create trouble tickets that are tailored for particular workgroups 117 and 119. When a workgroup, e.g., workgroup 117, encounters a new network problem and wishes to add a question or series of questions to the template for such a problem, it is beneficial for the user to be able to do so without the delay from software delivery cycles. Further it is beneficial for the workgroup 117 to be able to modify an existing template created by another workgroup, e.g., workgroup 119, rather than having to create the template from scratch. It is also beneficial in terms of efficiency for a user to be able to specify default values for template fields given a particular value of an attribute in one field.

According to particular embodiments, trouble ticket platform 113 stores generated and/or received trouble tickets at a local and/or a remote trouble ticket repository (not shown), but could be stored in the templates database 121. Additionally (or alternatively), trouble tickets may be stored to a memory of trouble ticket platform 113 and/or transmitted to NMS 111. As such, trouble ticket platform 113 also includes a communication interface (not shown) configured to transmit trouble tickets to NMS 111, either “on-demand” or as the result of a predefined schedule, such as periodically, e.g., after a selected time period. NMS 111 may in turn include received trouble ticket information (or parse trouble tickets for particular information), which then may be ported into an application, data store, module, etc., such as a prioritization report or mapping application.

As quality handling of network problems also generally entails a workforce, workforce management system 107 can communicate with NMS 111, either directly or via one or more networks. The system 107 is configured to automate the management of maintenance and repair services that are performed in response to output from NMS 111, as well as trouble ticket platform 113. The output may include particular trouble tickets requiring resolution, a prioritization schedule for conducting preventative maintenance, etc. Further, workforce management system 107 is configured to push (either automatically or in response to a request) certain status information to NMS 101 and/or trouble ticket system 105 upon the occurrence of a status change to a trouble ticket, preventative maintenance schedule, etc. For example, a completed preventative maintenance or repair procedure may warrant a status update message. This status information can be appended to one or more trouble tickets. In turn, NMS 111 may dynamically reprioritize a preventative maintenance schedule based on weather correlated trouble tickets and/or the status information provided by workforce management system 107.

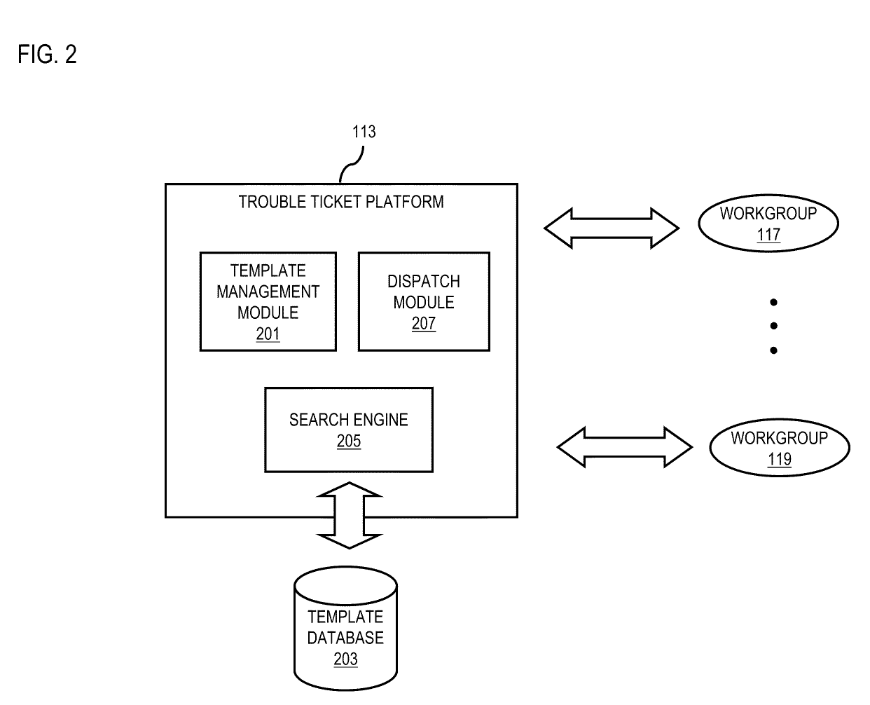

FIG. 2 is a diagram of trouble ticket platform 113 for use with a service provider network for creating, modifying, and sharing templates for trouble tickets. The trouble ticket platform 113 includes a template management module 201, a template database 203, a search engine 205, and a dispatch module 207. The template management module 201 allows a manager to generate, modify, enable, and disable templates, and fields within templates, and assign and unassign templates and fields to one or more workgroups. The database 203 stores the various templates, fields, and identifiers of the workgroups 117 and 119.

A user, for example a manager of the workgroup 117, can build a new template from scratch, from templates stored in database 203, and/or from fields stored in database 203. The user can then store the new template in database 203 and can assign the new template to one or more workgroups 119. Workgroups to which the new template is assigned can search for and retrieve the template using search engine 205. When a customer in a particular workgroup needs to create a trouble ticket, the dispatch module 207 retrieves the appropriate template assigned to that workgroup from the database 203 and dispatches it to the customer.

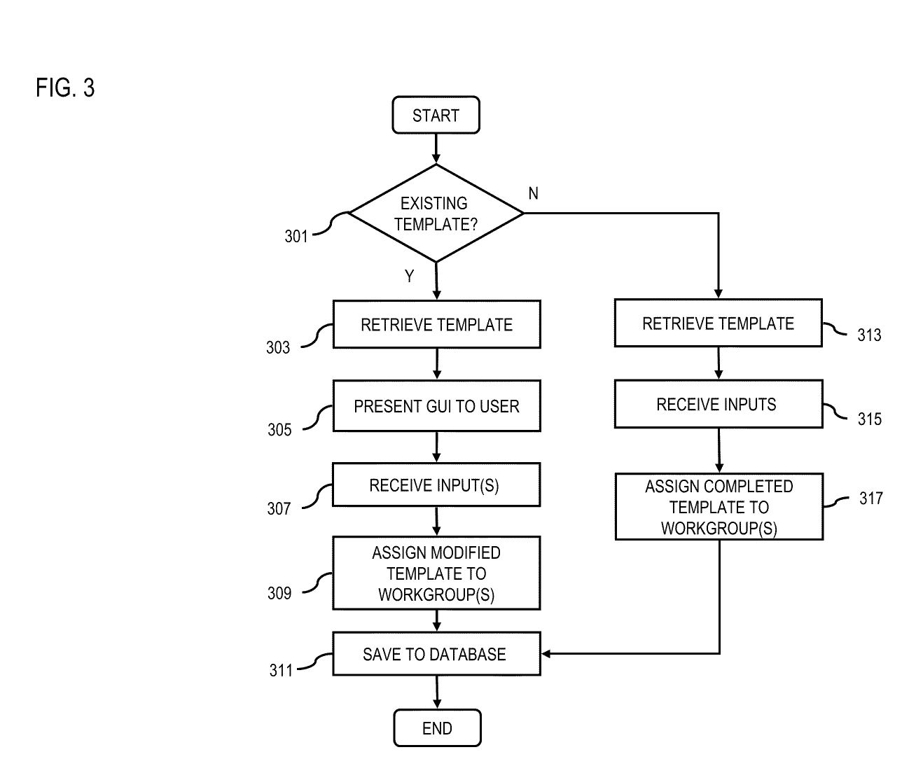

FIG. 3 is a flowchart of a template creation/modification process, according to various embodiments. In step 301, a determination is made as to whether a template, which corresponds to a service or product associated with the user, already exists. If the user finds a template for which the user has privileges, the appropriate template is retrieved from the database 203, at step 303. In step 305, graphical user interface (GUI) is presented to the user showing all current fields in the template and all available fields.

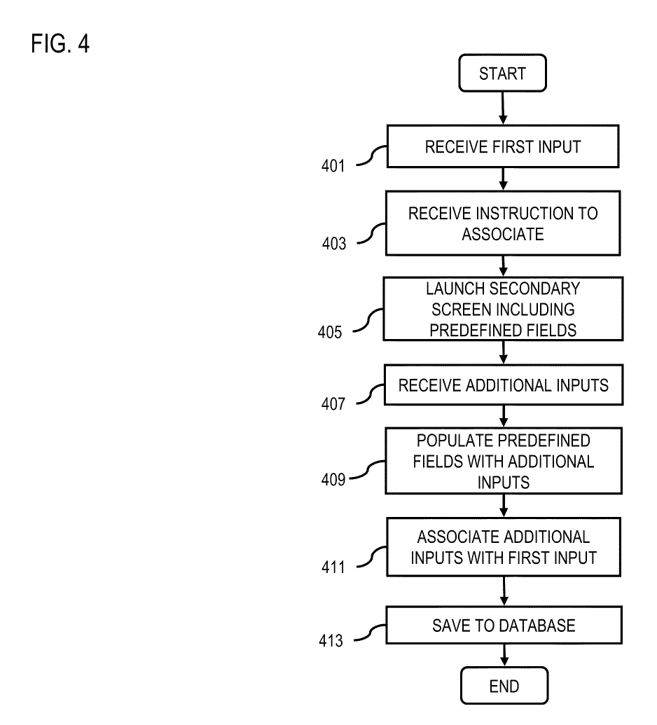

In step 307, the user provides input relating to the template creation. For example, the input may select fields to be added or modified, may add or change attributes of selected fields, may delete fields, or may associate with a particular value for a field attribute default values for other fields. The process of associating is detailed below with respect to FIG. 4. Once all inputs are received and inserted into the template, as in step 309, the modified template is assigned to one or more workgroups associated with trouble tickets for the service or product for which the template was created. The template and assignment are then saved to database 203 in step 311.

If no existing template is found at step 301, a GUI is presented to the user showing available fields (step 313). In step 315, inputs are received from the user. The inputs may select desired fields to be added. For each field selected, inputs may include values for various attributes of the selected field. Also, inputs might include an instruction to associate with a particular value for a field attribute default values for other fields. After all inputs are received and populated into the template, the completed template is assigned to one or more workgroups in step 317. As with the modified template, the completed new template is then saved to the database 203 in step 311.

FIG. 4 is a flowchart of a process associating fields with a field value in a template for a trouble ticket management system, according to various embodiments. In step 401, a first input is received from the user for a particular value for a field attribute. In step 403, an instruction is received from the user to associate the attribute value. The instruction may be received via a selection of an associated mapping button on a screen of the GUI. The instruction causes a secondary screen to launch at step 405. The secondary screen includes between one and fifteen predefined fields for which the user can assign default values to be associated with the field attribute.

In step 407, additional inputs are received. The additional inputs specify the default values for one or more of the predefined fields. The fields are then populated with the additional inputs in step 409, and the default values for the fields are associated with the first input at step 411. Finally, the association is saved to the database 203 at step 413.

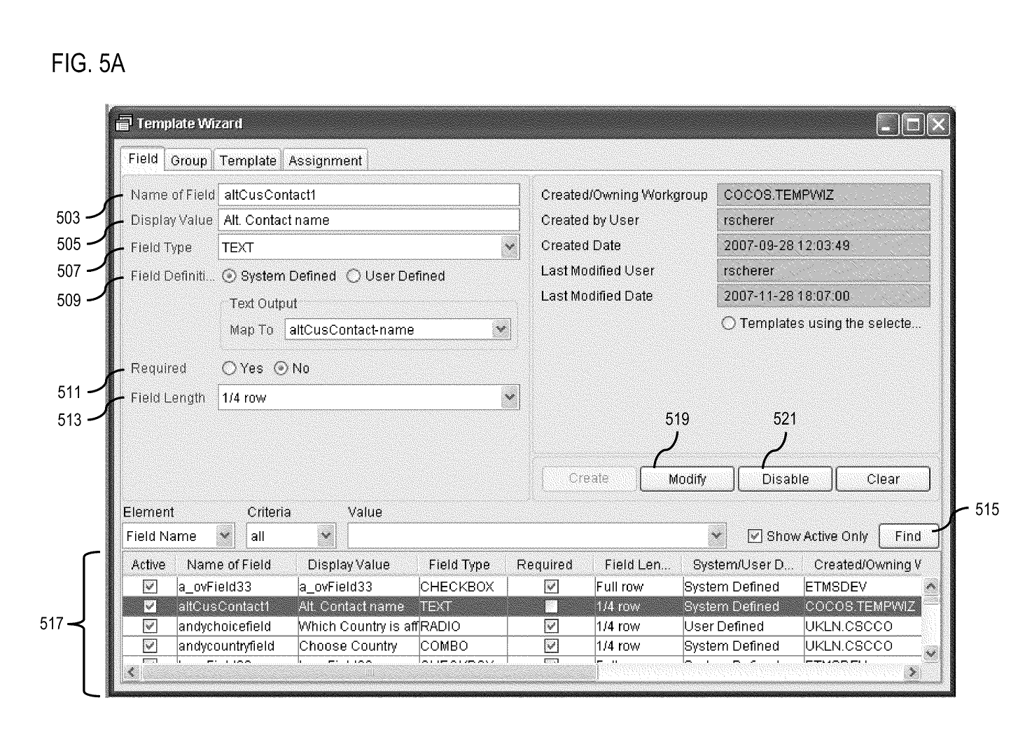

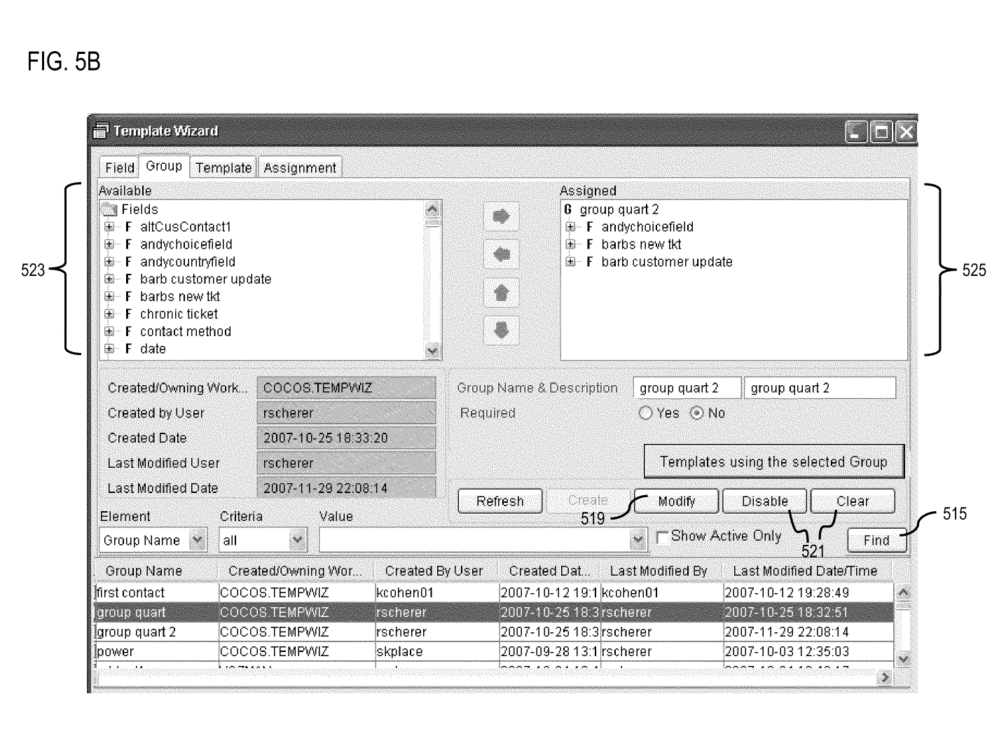

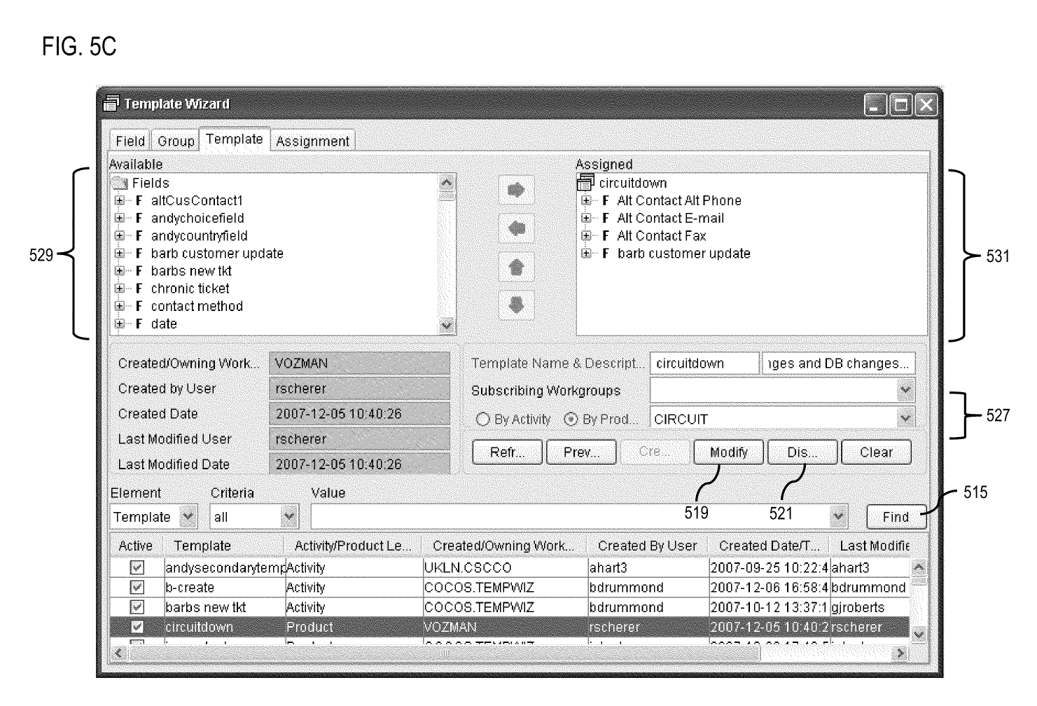

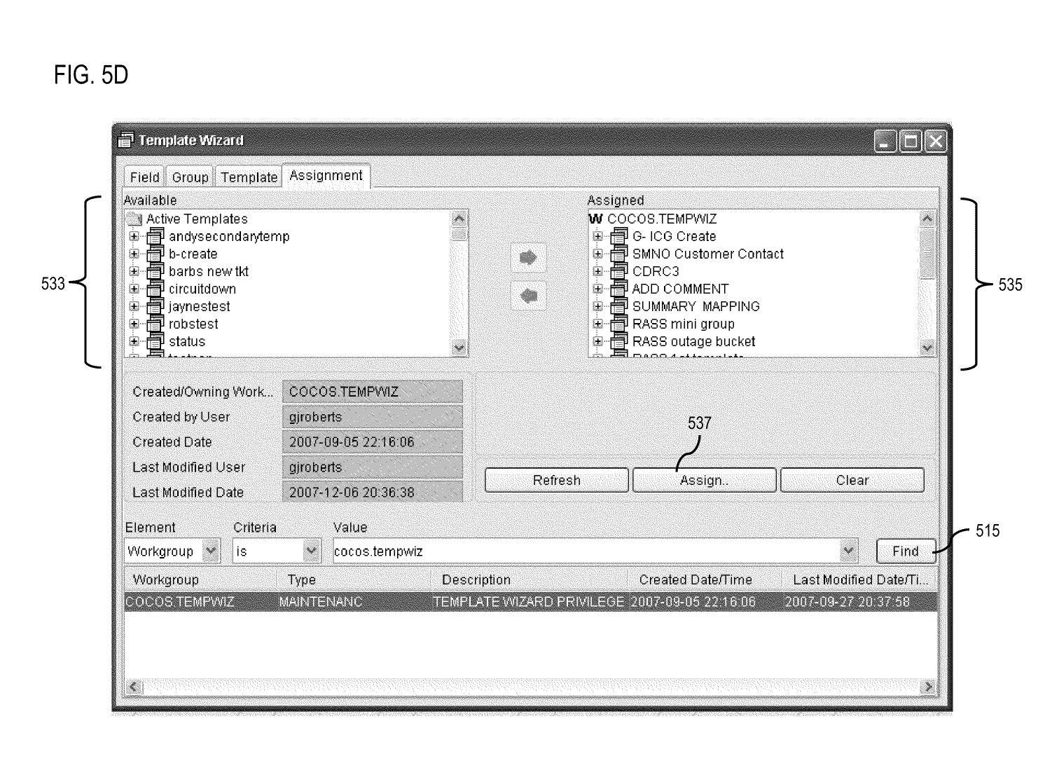

According to certain embodiments, template management module 201 provides a user with a GUI. FIGS. 5A-5D illustrate examples of four screens presented to a user according to the selection of one of four tabs 501, Field, Group, Template, and Assignment, respectively. In FIG. 5A the user has selected the tab entitled Field. This screen allows the user to define a field to be used in a template. The user adds required data to various areas of the screen defining attributes of the field, such as the name of the field 503, the display value 505, the field type 507, field definition 509, required 511, and field length 513. In one embodiment, the field name is unique. The display value designates what text is to appear next to the field in the template.

As shown, the field type indicates, for example, whether the field will have checkboxes (which are either user defined or system defined, for example via a dropdown box with available fields) or whether the field will be designated as “Combo,” wherein the user can associate a particular value with up to fifteen other system defined fields. To perform such an association, the user launches a secondary dialog via an associated mapping button and assigns default values for the system defined fields. During template use, when the user chooses a user defined value from a combo box which has an associated field mapping, the default values for the associated fields will be automatically propagated in accordance with the mapping. Other field types may include date, dialog, filler, hyperlink, info., radio button, short time, text, and text area.

Other read-only areas that contain field attributes may appear on the screen. These areas include: created/owning workgroup (defines which workgroups have the privilege to modify the field), created by user (the name of the field creator), create date (the date the field was created), last modified user (the last person who modified the field), last modified date, templates using the selected field, create, modify, disable, enable, and clear.

According to one embodiment, fields can be searched by selecting the find button 515 to activate search engine 205. The fields and attributes will be retrieved from database 203 and listed as shown at 517, with each column displaying a different attribute. If the user is authorized to modify the field, the user may select the displayed field, make changes to the field attributes, and select the modify button 519. The modified field may then be stored in database 203. In addition, the modified field will replace the existing field in all templates and groups using the field. Alternatively, a privileged user may disable the selected field, if it is not part of a group or template, by selecting the disable button 521, or enable the selected field, making it available for use in a group or template, by selecting the enable button (not shown). Any changes made to the status of the field will be save to the database.

FIG. 5B graphically illustrates a screen that is presented to the user upon selection of the group tab. A group is a combination of fields that may be used together in a template. Groups may be searched by selecting the Find button 515 to activate search engine 205. Groups will be retrieved from database 203 and presented to the user with each column displaying a different attribute of the groups. Group attributes include active/inactive, group name, created/owing workgroup, created by user, created date/time, last modified by, and last modified data/time. For a new group or a group selected as the result of a search, available fields 523 as well as the assigned, or previously grouped, fields 525 will be listed. A user may select fields from the available fields list to add the fields to the group, or may select fields from the grouped fields list to remove them from the group. Once a new group is complete, the user, if authorized, may select a create button to save the group to database 203. Once an existing group is modified, the user, if authorized, may select a modify button 519 to save the group to database 203. In addition, a privileged user may disable/enable a selected group by selecting a disable/enable button 521. However, a group cannot be disabled if part of an enabled template.

FIG. 5C graphically illustrates a screen presented to a user when the template button is selected. To create a new template for a particular activity or product of the service provider, the user enters a unique template name and a template description. The user then, at 527, specifies “by activity” or “by product” with radio buttons and the specific activity or product with the combo box to the right of the radio buttons. Available fields are then listed at 529 and assigned fields are presented at 531 once they are assigned. Similarly available and assigned groups may be presented to the user. The user may select fields and groups for the template and may specify the order in which they are to be presented. When the template is complete, the user, if authorized to create a template for the selected activity or product, selects a create button, and the new template is stored in database 203. The templates will then be available for the creation of trouble tickets for the specified activities or products by workgroups to which the templates are assigned.

To modify a template, the user may search existing templates by selecting the find button 515. Existing templates will be presented to the user, with each column displaying a different template attribute. When the user selects a template, existing attributes are automatically populated, and the user may make changes thereto in a manner similar to the process for modifying fields and groups. When a template is complete, the user, if authorized, may select the modify button 519 and the modified template will be stored in database 203. Likewise, an authorized user may disable/enable a selected template by selecting the disable/enable button 521, and the changes will be saved to database 203.

FIG. 5D graphically illustrates the assignment tab. The assignment tab provides the user with the ability to assign a template to one or more workgroups. The user may search for workgroups by selecting the find button 515. The workgroups will be presented with the columns indicating the workgroup, workgroup type, workgroup description, created date/time, and last modified date/time. When the user selects a particular workgroup the attributes will be automatically populated in the appropriate areas of the screen, and a list of available templates 533 and previously assigned templates 535 for the selected workgroup will be presented. To assign a template to the selected workgroup, the user selects an available template and selects the assign button 537 to save the assignment to database 203.

The above described processes, in certain embodiments, advantageously permits an efficient creation and sharing of templates to improve trouble ticketing. This enhances response time in solving issues relating to the services of a service provider.

One of ordinary skill in the art would recognize that the processes described above may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

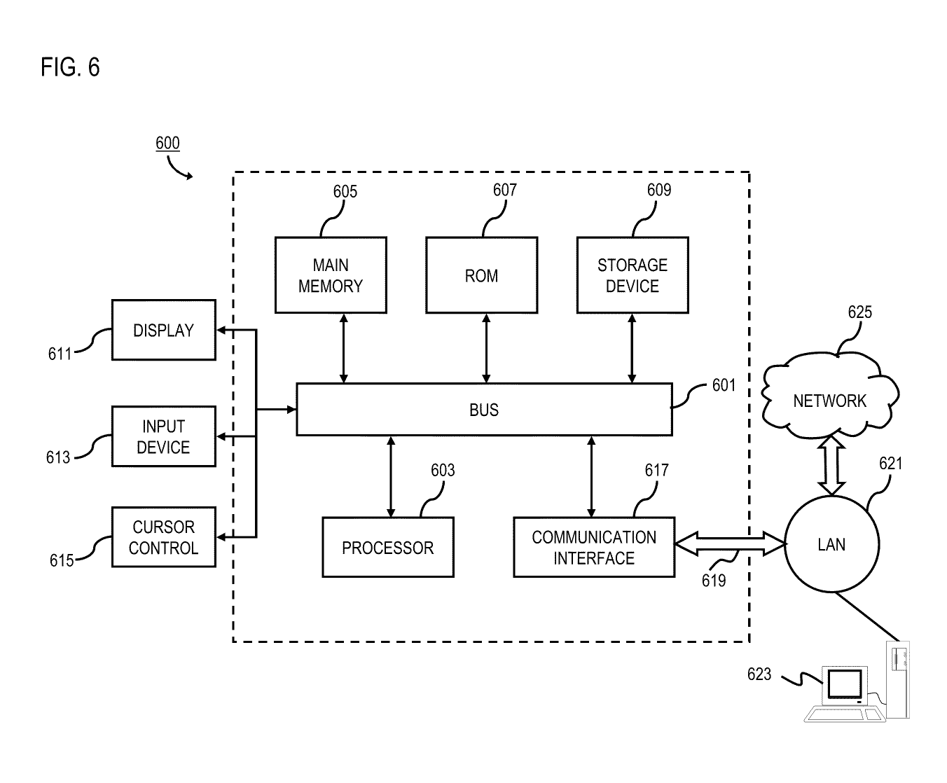

FIG. 6 illustrates a computer system 600 upon which an embodiment according to the present invention can be implemented. The computer system 600 includes a bus 601 or other communication mechanism for communicating information and a processor 603 coupled to the bus 601 for processing information. The computer system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computer system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computer system 600 may be coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is a cursor control 615, such as a mouse, a trackball, or cursor direction keys, for communicating direction information and command selections to the processor 603 and for controlling cursor movement on the display 611.

According to one embodiment of the invention, the processes described herein are performed by the computer system 600, in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the present invention. Thus, embodiments of the present invention are not limited to any specific combination of hardware circuitry and software.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, a telephone modem, or any other communication interface to provide a data communication connection to a corresponding type of communication line. As another example, communication interface 617 may be a local area network (LAN) card (e.g. for Ethernet™ or an Asynchronous Transfer Model (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a PCMCIA (Personal Computer Memory Card International Association) interface, etc. Although a single communication interface 617 is depicted in FIG. 6, multiple communication interfaces can also be employed.

The network link 619 typically provides data communication through one or more networks to other data devices. For example, the network link 619 may provide a connection through local network 621 to a host computer 623, which has connectivity to a network 625 (e.g. a wide area network (WAN) or the global packet data communications network now commonly referred to as the “Internet”) or to data equipment operated by a service provider. The local network 621 and the network 625 both use electrical, electromagnetic, or optical signals to convey information and instructions. The signals through the various networks and the signals on the network link 619 and through the communication interface 617, which communicate digital data with the computer system 600, are exemplary forms of carrier waves bearing the information and instructions.

The computer system 600 can send messages and receive data, including program code, through the network(s), the network link 619, and the communication interface 617. In the Internet example, a server (not shown) might transmit requested code belonging to an application program for implementing an embodiment of the present invention through the network 625, the local network 621 and the communication interface 617. The processor 603 may execute the transmitted code while being received and/or store the code in the storage device 609, or other non-volatile storage for later execution. In this manner, the computer system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the present invention has been described in connection with a number of embodiments and implementations, the present invention is not so limited but covers various obvious modifications and equivalent arrangements, which fall within the purview of the appended claims. Additionally, the features of the present invention can be combined in a numerous combinations and permutations, in which the appended claims are illustrative in nature.

What is claimed is:

1. A method comprising:
presenting a graphical user interface (GUI) to a user associated with a service provider;
receiving one or more inputs from the user for creation or modification of a template customized for the user for a trouble ticket corresponding to one of a plurality of services of the service provider; and
assigning the template to one or more of a plurality of workgroups defined according to the service.

2. The method according to claim 1, wherein the GUI comprises one or more screens specifying a field corresponding to the service.

3. The method according to claim 2, wherein one of the screens comprises one or more areas for defining attributes of the field, and the one or more inputs are received in the one or more areas.

4. The method according to claim 3, further comprising:
receiving an instruction to associate an attribute value;
receiving additional inputs; and
associating the one or more inputs with the additional inputs.

5. The method according to claim 4, wherein the step of associating comprises:
launching a secondary screen including predefined fields; and
receiving the additional inputs in the predefined fields.

6. The method according to claim 4, comprising associating a predetermined number of inputs with the one or more inputs.

7. The method according to claim 3, wherein the attributes include name of field and field type.

8. An apparatus comprising:
a template management module configured to present a graphical user interface (GUI) to a user associated with a service provider and to receive one or more inputs from the user for creation or modification of a template customized for the user for a trouble ticket corresponding to one of a plurality of services of the service provider; and
a dispatch module configured to assign the template to one or more of a plurality of workgroups defined according to the service.

9. The apparatus according to claim 8, wherein the GUI comprises one or more screens specifying a field corresponding to the service.

10. The apparatus according to claim 9, wherein one of the screens comprises one or more areas for defining attributes of the field, and the one or more inputs are received in the one or more areas.

11. The apparatus according to claim 10, the template management module further configured to receive additional inputs, and to associate the one or more inputs with the additional inputs.

12. The apparatus according to claim 11, wherein the template management module is further configured to launch a secondary screen including predefined fields, and to receive the additional inputs in the predefined fields.

13. The apparatus according to claim 11, wherein the template management module is further configured to associating a predetermined number of inputs with the one or more inputs.

14. The apparatus according to claim 10, wherein the attributes include name of field and field type.

15. A system comprising:
a trouble ticket platform configured to provide creation of a trouble ticket from a template, the trouble ticket corresponding to one of a plurality of network resources associated with a network provider,
wherein the trouble ticket platform includes a template management module configured to present a graphical user interface (GUI) to a user associated with the service provider and to receive one or more inputs from the user for creation or modification of the template customized for the user for the trouble ticket.

16. The system according to claim 15, wherein the GUI comprises one or more screens specifying a field corresponding to the resource.

17. The system according to claim 16, wherein a screen comprises one or more areas for defining attributes of the field, and the one or more inputs are received in the one or more areas.

18. The system according to claim 17, wherein the template management module is further configured to:
receive an instruction to associate an attribute value;
receive additional inputs; and
associate the one or more inputs with the additional inputs.

19. The system according to claim 15, wherein the template management module is further configured to:
launch a secondary screen including predefined fields; and
receive the additional inputs in the predefined fields.

20. The system according to claim 15, wherein the template management module is configured to associate a predetermined number of inputs with the one or more inputs.
